(19) United States
(12) Patent Application Publication
(10) Pub. No.: US 2010/0026752 A1
(43) Pub. Date: Feb. 4, 2010

(54) METHOD OF MANUFACTURING LIQUID EJECTING HEAD AND LIQUID EJECTING APPARATUS

(75) Inventors: Yoshihiro KOBAYASHI, Matsumoto-shi (JP); Makoto KAWAMOTO, Matsumoto-shi (JP); Masato MITSUHASHI, Hara-mura (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/510,459

(22) Filed: Jul. 28, 2009

(30) Foreign Application Priority Data
Jul. 29, 2008 (JP) 2008-195520
May 8, 2009 (JP) 2009-113997

(51) Int. Cl. B41J 2/175; B21D 53/00

(52) U.S. Cl. 347/20; 29/890.1

(57) ABSTRACT

Provided is a method of manufacturing a liquid ejecting head where a head body is fixed in a frame, the head body having a plurality of nozzle rows in which a plurality of nozzles is disposed in rows. The method includes forming the nozzle rows by performing multiple times a process for forming the nozzles by punches while relatively moving the punches and a workpiece on which the nozzles are formed, and performing relative alignment of each of the plural head bodies on the basis of predetermined nozzles selected from among the nozzle rows in accordance with the forming sequence, when the head body is attached to the frame.

### BACKGROUND

1. Technical Field

The present invention relates to a method of manufacturing a liquid ejecting head of which head bodies ejecting droplets from nozzles are fixed on a frame, and a liquid ejecting apparatus provided with the liquid ejecting head manufactured by the manufacturing method.

2. Related Art

An illustrative example of the liquid ejecting apparatus which mounts the liquid ejecting head includes, for example, an ink jet recording apparatus. The ink jet recording apparatuses commonly used are serial types where the print operation is performed while an ink jet recording head mounted in a carriage is moved, and line types where the print operation is performed by ejecting ink from the nozzles which are disposed over an entire recording medium.

The ink jet recording head mounted in the ink jet recording apparatus includes an ink jet recording head composed of a plurality of head bodies to which ink is supplied from an ink tank or the like may be used. In particular, an ink jet recording head is included which is configured to fix a plurality of ink jet heads (head bodies) as aligned to a plate (frame), and to have nozzles disposed over the full width of the recording medium (for example, see the pamphlet of WO2004/022344).

In a configuration where a plurality of head bodies is fixed to the frame in this way, it is necessary to fix each head body, as aligned with a high degree of accuracy, to the frame. This is because if each head body is not aligned with a high degree of accuracy, deviation may occur in the pitch of nozzles located at the joints of each head body.

A number of methods are proposed as methods of aligning the head bodies. One of these proposed methods, for example, includes the method in which alignment marks previously provided to a transparent plate are aligned with the nozzles of the nozzle heads (head bodies), so that the nozzle heads are aligned in a retention frame with a high degree of accuracy (for example, see JP-A-2003-231259).

Here, the nozzles provided to the head bodies are formed by, for example, the punches (for example, see JP-A-2004-322606). When a plurality of nozzles are formed by the punches in this way there may be a case where, for example, the shape of nozzles previously formed change from a circle to an ellipse by the transformation of a substrate (workpiece) which occurs in forming the nozzles, and the displacement occurs in the nozzles previously formed due to so-called damming or the like.

For this reason, when the head bodies are aligned as described above on the basis of any of the nozzles (particularly, the early-formed nozzles), there is a drawback that the head bodies cannot be aligned with a high degree of accuracy.

### SUMMARY

An advantage of some aspects of the invention is to provide a method of manufacturing a liquid ejecting head capable of aligning head bodies with a high degree of accuracy, and a liquid ejecting apparatus in which ejecting characteristics of droplets are improved by aligning the head bodies with a high degree of accuracy.

According to a first aspect of the invention, a method of manufacturing a liquid ejecting head is provided where a head body is fixed in a frame, the head body having a plurality of nozzle rows in which a plurality of nozzles is disposed in rows. The method includes forming the nozzle rows by performing multiple times a process for forming the nozzles by punches while relatively moving the punches and a workpiece on which the nozzles are formed, and performing relative alignment of each of the plural head bodies on the basis of predetermined nozzles selected from among the nozzle rows in accordance with the forming sequence, when the head body is attached to the frame.

In such an embodiment of the invention, the alignment of the head body is performed on the basis of the predetermined nozzles selected in accordance with the forming sequence, so that each head body can be aligned with a high degree of accuracy and attached to the frame without being affected by deformation and displacement of the nozzles which occurs in forming the nozzles.

It is preferable to form the nozzle rows while relatively moving the punches and the workpiece in one direction, and perform the relative alignment of each of the plural head bodies on the basis of the nozzles located at a terminal portion in a processing direction of the nozzle rows. Herewith, it is possible to align each head body with a higher degree of accuracy and attach it to the frame.

It is preferable to perform the alignment of the head body on the basis of the nozzles formed last among those of the nozzle rows. Further, it is preferable to further include attaching an identification mark in the vicinity of the nozzles used as the basis of the alignment of the head body, after the nozzle rows are formed. Herewith, it is possible to prevent false recognition of the nozzles used as the basis and align the head body more certainly with a high degree of accuracy, when the head body is aligned.

Further, it is preferable to simultaneously form the plurality of nozzles used as the basis of the alignment of the head body, when the alignment of the head body is performed on the basis of a plurality of nozzles. Herewith, even though a slight deformation amount or displacement occurs at the nozzles used as the basis, the deformation amount or the displacement amount between the nozzles used as the basis are substantially identical. Therefore, it is possible to achieve good alignment of the head body.

According to a second aspect of the invention, a liquid ejecting apparatus including a liquid ejecting head manufactured by the method of manufacturing the above-mentioned liquid ejecting head is provided. In accordance with an embodiment of the invention, each head body is aligned well, thereby improving the ejecting characteristics of the droplets.

### BRIEF DESCRIPTION OF THE DRAWINGS

The invention will be described with reference to the accompanying drawings, wherein like numbers reference like elements.

FIG. 1 is a schematic perspective view of a recording head according to the first embodiment of the invention.

FIG. 2 is a bottom view showing the main portions of the recording head according to the first embodiment of the invention.

FIG. 3 is a cross-sectional view showing the main portions of the recording head according to the first embodiment of the invention.

FIG. 4 is a schematic view showing a method of forming nozzles according to the first embodiment of the invention.

FIG. 5 is a bottom view showing a head body according to the first embodiment of the invention.

FIGS. 6A and 6B are schematic views showing an example of the forming sequence of the nozzles.

FIG. 7 is a schematic view of a liquid ejecting apparatus according to an embodiment.

### DESCRIPTION OF EXEMPLARY EMBODIMENTS

Hereinafter, the embodiments of the invention will be described in detail.

### First Embodiment

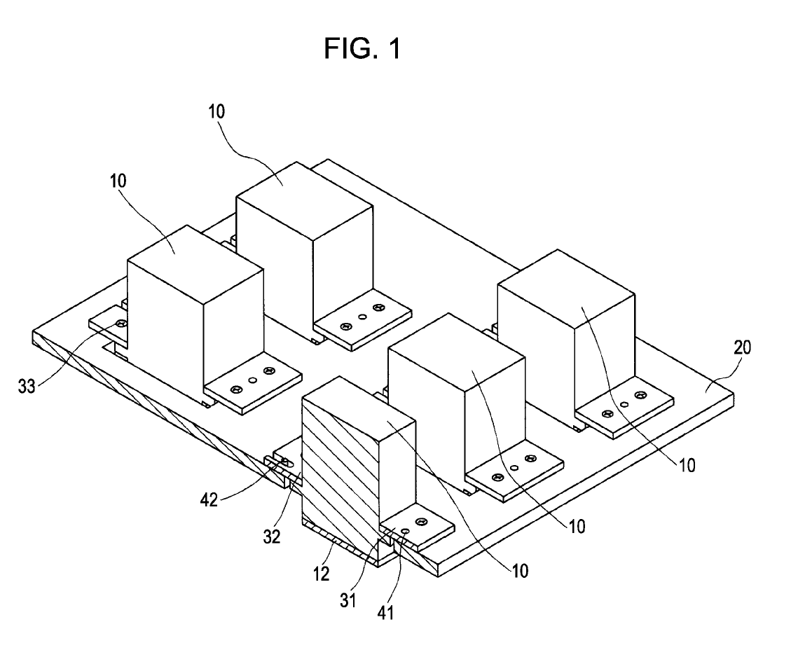

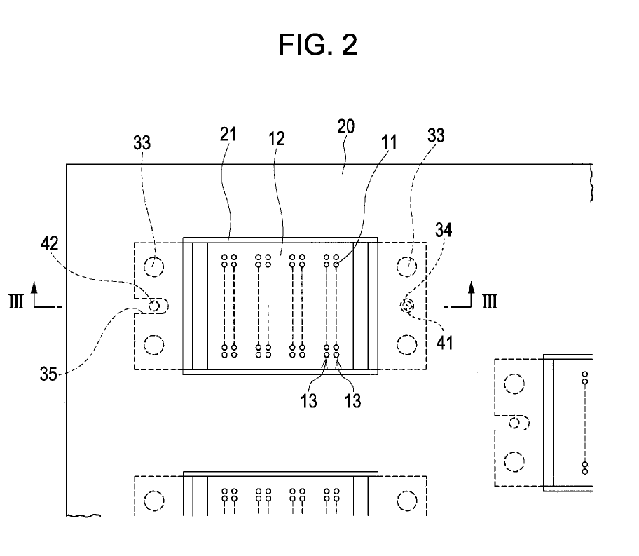

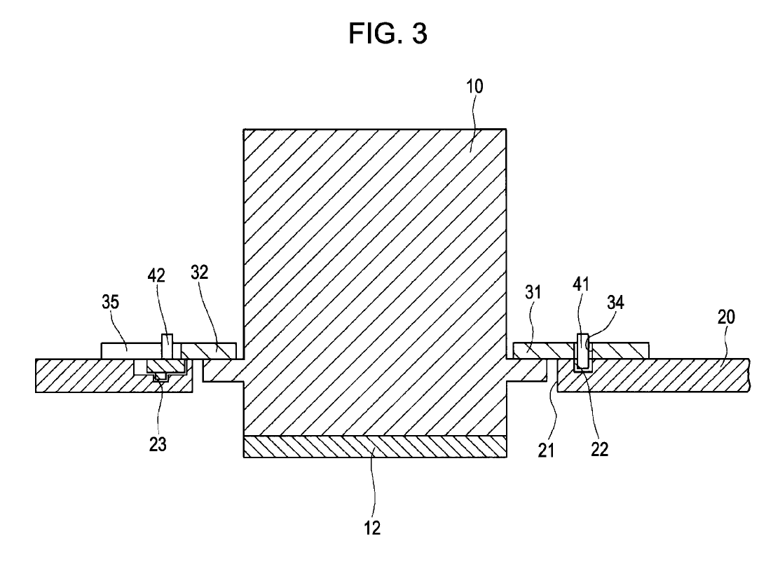

FIG. 1 is a perspective view schematically showing an ink jet recording head, which is an example of a liquid ejecting head, according to the first embodiment of the invention, FIG. 2 is a bottom view showing a portion of the ink jet recording head, and FIG. 3 is a cross-sectional view taken along the line III-III of FIG. 2.

As shown in the figures, the ink jet recording head, according to this embodiment, includes a plurality of head bodies 10, and a frame 20 to which the plurality of head bodies 10 are attached as aligned. In this embodiment, the plurality of head bodies 10 is disposed in a so-called zigzag shape and attached to the frame 20.

Each of the head bodies 10 is provided with an ink flow path such as a pressure-generating chamber, and a pressure-generating unit such as a piezoelectric element generating pressure in the pressure-generating chamber or a heater element, which are not shown in the drawings. Since such a configuration is well known, the detailed descriptions and the drawings are omitted. The head body 10 has a nozzle plate 12 in which nozzles 11 communicating with each pressure-generating chamber are punched and disposed at the side of its bottom end face. A plurality of nozzle rows 13, in which a plurality of nozzles 11 is arranged in a linear fashion, is arranged in transverse line on the nozzle plate 12. In this embodiment, for example, each of the nozzle rows 13 is constituted by arranging the nozzles 11 in a linear fashion at an arrangement density of 180 dpi, and such nozzle rows 13 are disposed in eight rows on the nozzle plate 12. Each of the head bodies 10 is constituted so that black ink and multi-colored color ink are each ejected from the nozzles 11 of each of these nozzle rows 13. In addition, the number of the nozzle rows 13 is not specifically limited, but may be appropriately determined in accordance with the number of ink colors to be ejected or the like.

Further, a first attachment plate 31 and a second attachment plate 32 are fixed on the external periphery of each head body 10. These first and second attachment plates 31 and 32 are fixed overhanging both external sides of each head body 10 in a direction perpendicular to the nozzle rows 13. On the other hand, mounting holes 21, in which each head body 10 is mounted, are formed in the frame 20.

When the head body 10 is mounted in each mounting hole 21 of this frame 20, the first attachment plate 31 and the second attachment plate 32 abut on the frame 20, and so the head body 10 is locked in the frame 20. These first and second attachment plates 31 and 32 are then fixed on the frame 20 by screw members 33. That is to say, each of the head bodies 10 is attached to the frame 20 by the first attachment plate 31 and the second attachment plate 32.

The method of fixing the first and second attachment plates 31 and 32 on the head body 10 is not specifically limited, but although not shown in the drawings they may, for example, be fixed by the screw members similarly to fixing on the frame 20.

At this point, when the first and second attachment plates 31 and 32 are fixed on the frame 20 by the screw members 33 as described above, that is, when the head body 10 is attached to the frame 20, it is necessary to align the head body 10 with a high degree of accuracy. As a result, the relative position relationships of each of the plural head bodies 10 being aligned with a high degree of accuracy are achieved. The reason for performing such an alignment is that the so-called banding of shading unevenness, or the like, is suppressed and prevented from occurring in printed matter by the incorrect relative positional relationships of each of the plural head bodies 10. For this reason, in this embodiment, the alignment of the head body 10 with respect to the frame 20 is performed on the basis of a pin which is inserted into an inserting portion formed in the first and second attachment plates 31 and 32, as described above.

As shown in FIG. 3, the first attachment plate 31 is provided with a through hole 34 used as the inserted portion, and the second attachment plate 32 is provided with a notch portion 35 used as the inserted portion. On the other hand, the frame 20 is provided with a first concave portion 22 corresponding to the through hole 34 of the first attachment plate 31, and a second concave portion 23 corresponding to the notch portion 35. A fixing pin 41, which serves as the basis pin, is inserted into the through hole 34 and the concave portion 22, and an adjusting pin 42 is inserted into the notch portion 35 and the second concave portion 23. This adjusting pin 42, in this embodiment, is constituted by an eccentric pin of which the rotational center at the side of the second attachment plate 32 and the rotational center at the side of the frame 20 are made eccentric.

In such a configuration, when the head body 10 is attached to the frame 20, the head body 10 is first mounted in the predetermined mounting hole 21 of the frame 20, the fixing pin 41 is inserted into the through hole 34 and the concave portion 22, and the adjusting pin 42 is inserted into the notch portion 35 and the second concave portion 23. And then, the head body 10 is aligned with a high degree of accuracy by rotating the adjusting pin 42 composed of the eccentric pin. That is, in this condition the head body 10 is not fixed on the frame 20, but angles of the head body 10 change by rotating the adjusting pin 42 by making the fixing pin 41 serve as a fulcrum of rotation. Therefore, it is possible to fine adjust the position of the head body 10 by this movement to align the head body 10 with a high degree of accuracy. In other words, it is possible to align the head body 10 with a high degree of accuracy on the basis of the fixing pin 41 and the adjusting pin 42.

For a method of aligning the head body 10, for example, an operation is performed in which positions of the alignment marks previously provided to the transparent plate and positions of the predetermined nozzles 11 of the head body 10 are adjusted. In other words, the position alignment between the alignment marks and the nozzles 11 is performed by rotating the adjusting pin 42 to change the angles of the head body 10, as described above. The method of adjusting positions of the alignment marks previously provided to the transparent plate and positions of the predetermined marks of the head body 10, for example, may adopt a known method such as a method described in JP-A-2003-231259. Accordingly, the detailed description thereof is omitted.

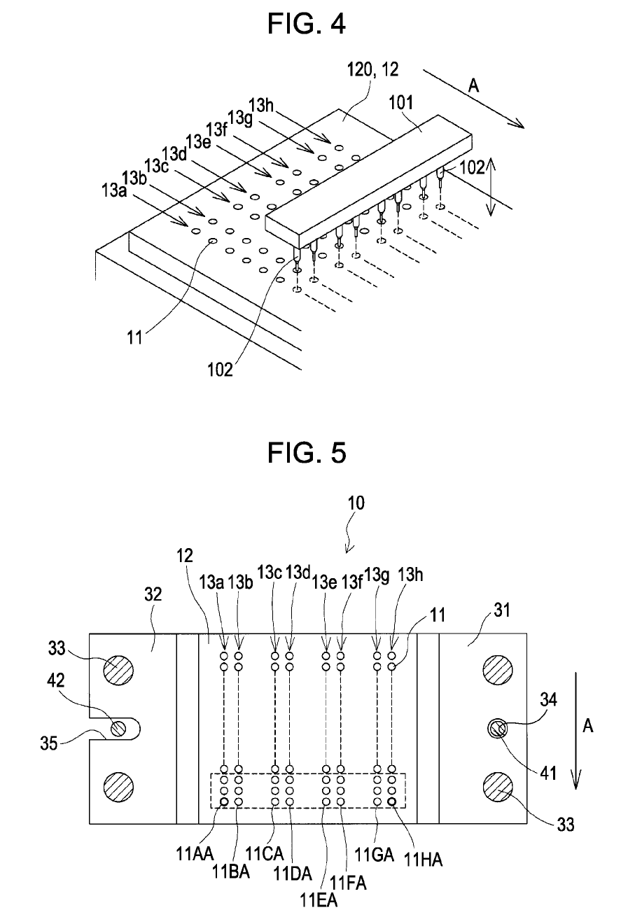

Here, the nozzles 11 of each head body 10 are formed by punching using a die and a punch. In particular, for example, each of the nozzles 11, which constitutes each of the nozzle rows 13a to 13h of the first to eighth rows, is sequentially formed advancing (A direction in the drawing) from one end of the nozzle rows 13 to the other end thereof using eight punches 102 fixed in a punch holder 101, as shown in FIG. 4. In addition, there are two methods wherein one is to fix the position of the punches 102 and move in the processing direction a workpiece 120 (a substrate becoming the nozzle plate 12) on which the nozzles 11 are formed, and the other is to fix the workpiece 120 and move the punches 102 in the processing direction. However, any one of the methods may be employed as long as the workpiece 120 and the punches 102 can be relatively moved to process the workpiece.

The embodiment according to the invention is configured to perform the relative alignment of each of the plural head bodies on the basis of the predetermined nozzles selected in accordance with forming sequence thereof, among a plurality of nozzles 11 of each of the nozzle rows 13a to 13h formed by the punches 102 in this way. For example, when the nozzle rows 13 are formed while the punches 102 and the workpiece 120 are relatively moved in one direction, the alignment of the head body 10 is performed on the basis of the nozzles 11 located at a terminal portion of the processing direction (A direction in the drawing), as shown in FIG. 5. This “terminal portion” indicates that when a plurality of nozzles 11 is sequentially formed, the formation sequence is the last or in the range of the vicinity thereof. The range of the vicinity indicates that the range is from the nozzles 11 processed last (Nth, N is a natural number) to the nozzles 11 processed at (N-1)th and (N-2)th. This embodiment is configured to perform the alignment of the head body 10 on the basis of the nozzles 11AA and 11HA located at the farthest terminal of the nozzle rows 13a and 13h which are located at both ends.

Herewith, it is possible to align each of the plural head bodies 10 with an extremely high degree of accuracy. That is, in the nozzles 11AA to 11HA located at the terminal portion (particularly, the farthest terminal) of the processing direction in each of the nozzle rows 13a to 13h, the displacement does not occur due to so-called damming, or the like, when the nozzle rows 13 are formed. Therefore, it is possible to align each of the head bodies 10 with an extremely high degree of accuracy by aligning each of the head bodies 10 on the basis of the nozzles 11AA to 11HA.

Further, it is possible to prevent false recognition of the nozzles 11 used as the basis, when the head body 10 is aligned on the basis of the nozzles 11AA to 11HA located at the farthest terminal of the nozzle rows 13. Accordingly, it is possible to align the head body 10 with more certainty.

In addition, the nozzle 11AA of the nozzle row 13a and the nozzle 11HA of the nozzle row 13h are used as the basis of the alignment in this embodiment. However, of course, the nozzles 11BA to 11GA located at the farthest terminal of the other nozzle rows 13b to 13g may be used as the basis of the alignment.

Further, although the alignment of the head body 10 is performed on the basis of the nozzle 11AA and the nozzle 11HA located at the farthest terminal of the nozzle rows 13a and 13h in this embodiment, it is not necessary for it to be the nozzle 11AA and the nozzle 11HA located at the farthest terminal. For example, the alignment of the head body 10 may be performed on the basis of the nozzles, such as the second or third nozzles 11 from each end of the nozzle rows 13, which are located at the terminal portion of the above-described processing direction of the nozzle rows 13 surrounded by the dotted line in the drawing, and in which the displacement does not practically occur due to damming or the like. In other words, “the nozzles of the terminal” do not necessarily indicate the nozzles 11 of the farthest terminal of each nozzle row 13, but refer to those, such as the second or third nozzles 11 from the farthest terminal of each nozzle row 13, which are located at the terminal portion of the above-described processing direction of the nozzle rows 13 surrounded by the dotted line in the drawing, and in which the displacement does not practically occur due to damming or the like, and those sufficient to use in the alignment.

Further, in the case of the alignment on the basis of the last processed nozzles, which are the nozzles 11 other than the nozzles 11AA to 11HA located at the farthest terminal of each nozzle row 13 in this way, an identification mark for identifying the nozzles 11 used as the basis of the alignment is preferably attached to the surface of the workpiece 120. That is, it is preferable to attach the identification mark in the vicinity of the nozzles 11, and to identify the nozzle 11 used as the basis of the alignment by this identification mark. In addition, a method of forming the identification mark is not particularly limited, but for example, may be formed by a laser process or the like. By attaching the identification mark in this way, it is possible to prevent false recognition of the nozzles used as the basis, and align the head body 10 more certainly with a higher degree of accuracy.

Further, although the alignment of the head body 10 is performed on the basis of a plurality of nozzles 11, such plurality of nozzles 11 used as the basis is preferably formed at the same time by the punches 102. For example, when one basis is set to the second nozzle 11 from the end of the nozzle row 13a, preferably other bases are also set to the second nozzles 11 from the ends of the nozzle rows 13b to 13h.

In addition, so-called dummy nozzles, which are not practically used in ink ejecting, may be formed at the terminal portion of the nozzle row 13. In such case, the alignment of the head body 10 may be performed on the basis of this dummy nozzle. In other words, when the dummy nozzles are formed on the nozzle plate, the “nozzles” include not only the nozzles ejecting ink droplets, but also the dummy nozzles. Incidentally, the dummy nozzle has practically the same shape and practically the same size as those of a discharge nozzle.

### Other Embodiments

As described above, each of the embodiments according to the invention have been described, but the fundamental configuration according to the invention is not limited to the above descriptions.

For example, in the above-mentioned embodiments, examples have been described wherein a plurality of nozzles constituting each nozzle row is sequentially formed one-by-one advancing from one end to the other end, but the forming sequence of the nozzles is not limited to it.

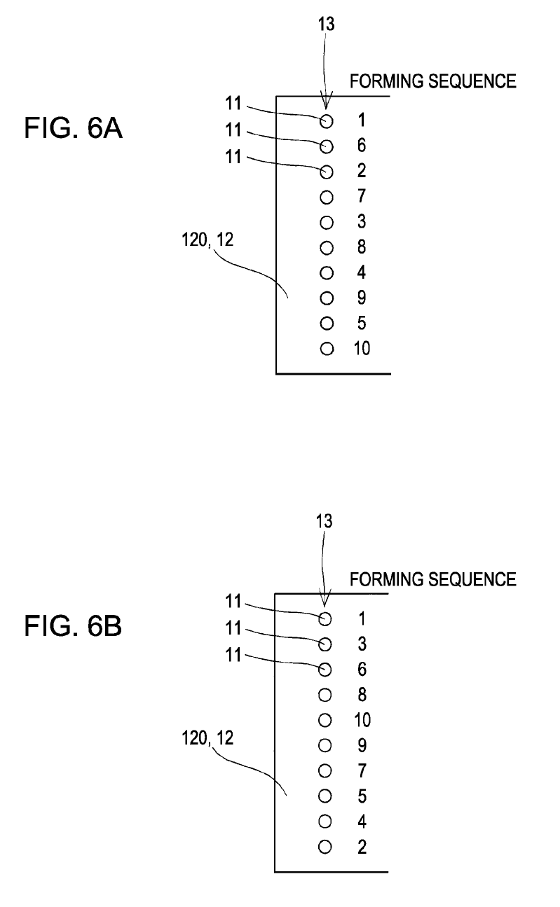

FIGS. 6A and 6B are, for example, views showing the forming sequence of the nozzles in forming the nozzle rows 13 each constituted by ten nozzles 11. As shown in FIG. 6A, for example, the odd-numbered nozzles 11 may be first formed from one end of the nozzles 13, and then the even-numbered nozzles 11 may be formed. Further, for example, the nozzles 11 may be sequentially formed advancing from both ends of the nozzle rows 13 to the central portion thereof as shown in FIG. 6B. Even in such a case, it is possible to position the head body with a high degree of accuracy similarly to the above-described embodiment on the basis of the predetermined nozzles 11 selected from among the nozzle rows 13 in accordance with the processing sequence, in other words, on the basis of the nozzles 11 formed at last (tenth) or prior to the second and third from the last.

Although the first and second attachment plates are constituted separately from the head body 10 in the above-described embodiment, the first and second attachment plates may be formed integrally with the head body 10.

Further, although the configuration where a plurality of head bodies 10 is attached to the frame 20 is illustrated as the ink jet recording head in the above-described embodiment, the number of the head bodies 10 is not specifically limited. The configuration where one head body 10 is attached to the frame 20 is also possible.

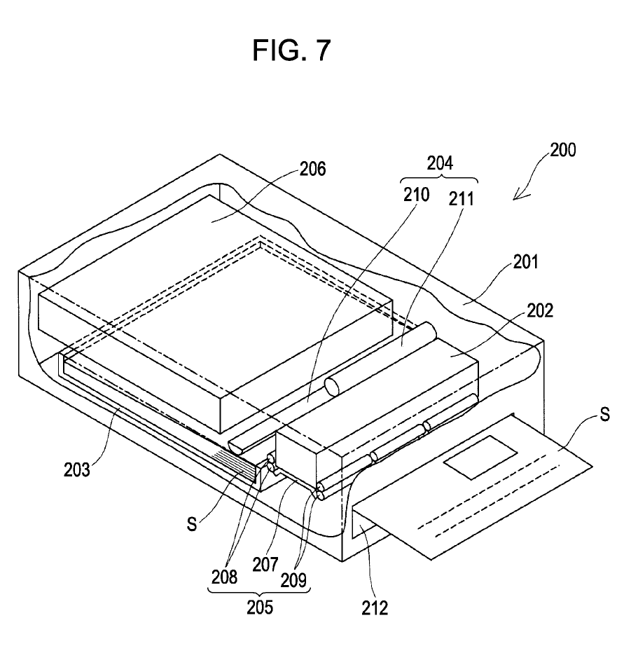

In addition, the above-described ink jet recording head, for example, is mounted in the so-called line type ink jet recording apparatus which performs printing on a recording medium such as a recording paper without moving the recording head. FIG. 7 is a schematic perspective view showing an example of the ink jet recording apparatus.

An ink jet recording apparatus 200 shown in FIG. 7 includes a recording head 202 having a plurality of head bodies 10 positioned by the above-described method within a housing 201, a receiving tray 203 for receiving a recording medium S, a feed section 204 for dispatching the recording medium S from the receiving tray 203, a transport section 205 for transporting the recording medium S fed from the feed section 204, and a control section 206 for performing the control of these sections, or the like.

The transport section 205 includes a paper feed guide 207 constituting a supply route in feeding the printing paper (recording medium) S, and paper feed rollers 208 and 209 which insert the printing paper S therebetween and dispatch it. The feed section 204 includes a substantially cylindrical paper feed roller 210 for paper feeding the printing paper S to the transport section 205, and a paper feed motor 211 which is coupled to the paper feed roller 210 via gears (not shown) which rotate the paper feed roller 210.

In such an ink jet recording apparatus, if print data are input, first the paper-feeding motor 211 is driven and a sheet of the printing paper S is dispatched from the receiving tray 203 to between a pair of paper feed rollers 208 by the rotation of the paper feed roller 210. And then, these pair of paper feed rollers 208 insert the printing paper S therebetween and dispatch, so that the printing paper S is transported along the paper feed guide 207 between the recording head 202 and the paper feed guide 207. At this time, the predetermined recording head 202 operates at the predetermined timing, so that information such as characters or figures is recorded in the printing paper S. After that, a pair of paper feed rollers 209 insert the printing paper S therebetween which is transported along the paper feed guide 207 and dispatch it, so that the printing paper S is discharged from an outlet 212.

The recording head 202, which includes a plurality of head bodies 10 positioned by the above-described method, is mounted in such a line type ink jet recording apparatus 200, so that good printing can be performed by improving the ejecting characteristic of the ink droplets.

In addition, one example of the ink jet recording apparatus includes the line type. However, the present invention, of course, is not limited to a method of manufacturing the recording head mounted in the line type ink jet recording apparatus, but can also be applied to a method of manufacturing the recording head mounted in the so-called serial type ink jet recording apparatus in which the recording head is mounted in the carriage, and which performs printing on a recording medium while moving the recording head.

Further, the present invention has been explained taking the ink jet recording head and the ink jet recording apparatus as examples of the liquid ejecting head and the liquid ejecting apparatus, respectively, in the above-described embodiment. However, the present invention generally covers a liquid ejecting head and a liquid ejecting apparatus provided with the liquid ejecting head, and, of course, can also be applied to a method of manufacturing a liquid ejecting head which ejects liquids other than ink. Other liquid ejecting heads include, for example, various types of recording heads used in an image recording apparatus such as a printer, a color material ejecting head used in the manufacture of a color filter such as a liquid crystal display, an electrode material ejecting head used in the formation of an electrode such as an organic EL display and an FED (field emission display), a bio-organics ejecting head used in the manufacture of a biochip, or the like.

What is claimed is:

1. A method of manufacturing a liquid ejecting head where a head body is fixed in a frame, the head body having a plurality of nozzle rows in which a plurality of nozzles is disposed in rows, the method comprising:
forming the nozzle rows by performing multiple times a process for forming the nozzles by punches while relatively moving the punches and a workpiece on which the nozzles are formed; and
performing relative alignment of each of the plural head bodies on the basis of predetermined nozzles selected from among the nozzle rows in accordance with the forming sequence, when the head body is attached to the frame.

2. The method of manufacturing the liquid ejecting head according to claim 1, further comprising:
forming the nozzle rows while relatively moving the punches and the workpiece in one direction, and performing the relative alignment of each of the plural head bodies on the basis of the nozzles located at a terminal portion in a processing direction of the nozzle rows.

3. The method of manufacturing the liquid ejecting head according to claim 1, further comprising:
performing the alignment of the head body on the basis of the nozzles formed last among those of the nozzle rows.

4. The method of manufacturing the liquid ejecting head according to claim 1, further comprising:
attaching an identification mark in the vicinity of the nozzles used as the basis of the alignment of the head body, after the nozzle rows are formed.

5. The method of manufacturing the liquid ejecting head according to claim 1, further comprising:
simultaneously forming the plurality of nozzles used as the basis of the alignment of the head body, when the alignment of the head body is performed on the basis of a plurality of nozzles.

6. A liquid ejecting apparatus comprising a liquid ejecting head manufactured by the method of manufacturing the liquid ejecting head according to claim 1.
